(19) United States
(12) Patent Application Publication
(10) Pub. No.: US 2026/0099420 A1
(43) Pub. Date: Apr. 9, 2026

(54) SOFTWARE BILL OF MATERIALS COMPONENT USAGE

(71) Applicant: Cisco Technology, Inc., San Jose, CA (US)

(72) Inventors: Walter Theodore HULICK, JR., Pearland, TX (US); Thomas SZIGETI, Vancouver (CA); David John ZACKS, Vancouver (CA)

(21) Appl. No.: 18/910,465

(22) Filed: Oct. 9, 2024

(51) Int. Cl. G06F 11/34; G06F 11/36; G06Q 10/0875

(52) U.S. Cl. CPC G06F 11/3466; G06F 11/3612; G06F 11/3644; G06Q 10/0875

(57) ABSTRACT

In one embodiment, a method herein comprises: obtaining a software bill of materials for an application, the software bill of materials listing a plurality of components associated with the application; monitoring runtime execution of the application; measuring usage of each individual component of the plurality of components associated with the application during the runtime execution of the application; and generating a usage report for the software bill of materials based on the usage each individual component of the plurality of components associated with the application during the runtime execution of the application.

### TECHNICAL FIELD

The present disclosure relates generally to computer networks, and, more particularly, to software bill of materials (SBOM) component usage.

### BACKGROUND

The Internet and the World Wide Web have enabled the proliferation of web services available for virtually all types of businesses. Due to the accompanying complexity of the infrastructure supporting the web services, it is becoming increasingly difficult to maintain the highest level of service performance and user experience to keep up with the increase in web services. For example, it can be challenging to piece together monitoring and logging data across disparate systems, tools, and layers in a network architecture. Moreover, even when data can be obtained, it is difficult to directly connect the chain of events and cause and effect.

Software Bill of Materials (SBOMs) are fast becoming a standard across the entire information technology (IT) field and allow for the quick identification of the software components involved in everything from transactions to application programming interfaces (APIs) in applications. In general, an SBOM is typically constructed today by the build system and then bundled with the software produced by that system.

SBOMs provide a formal record containing the details and supply chain relationships of various components used in building software. Traditionally, software developers and vendors often create products by assembling existing open source and commercial software components. The SBOM enumerates these components in a product. Accordingly, transparency from SBOMs aids multiple parties across the software lifecycle, including software developers, purchasers, and operators. However, SBOMs currently only provide a listing of components or “ingredients”, and do not provide any further insightful information.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computing system;

FIG. 2 illustrates an example network device/node;

FIG. 3 illustrates an example observability intelligence platform;

FIG. 4 illustrates an example environment in which software bill of materials (SBOM) component usage may be determined;

FIG. 5 illustrates an example runtime-enhanced SBOM;

FIG. 6 illustrates an example graphical representation of SBOM component usage; and

FIG. 7 illustrates an example procedure for providing component usage.

### DESCRIPTION OF EXAMPLE EMBODIMENTS

### Overview

According to one or more embodiments of the disclosure, techniques for software bill of materials (SBOM) component usage is provided herein. In one embodiment, an example method herein may comprise: obtaining a software bill of materials for an application, the software bill of materials listing a plurality of components associated with the application; monitoring runtime execution of the application; measuring usage of each individual component of the plurality of components associated with the application during the runtime execution of the application; and generating a usage report for the software bill of materials based on the usage each individual component of the plurality of components associated with the application during the runtime execution of the application.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

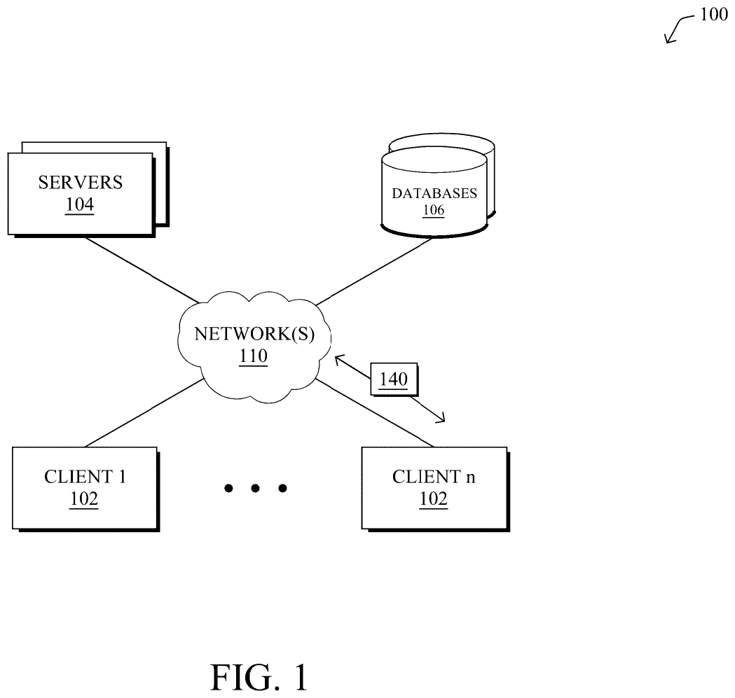

FIG. 1 is a schematic block diagram of an example simplified computing system (e.g., computing system 100) illustratively comprising any number of client devices (e.g., client devices 102, such as a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, the devices shown and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Network(s) 110 may include, for example, network backbones or other internetworking systems, and may include various customer edge (CE) routers interconnected with provider edge (PE) routers in order to communicate across a core network to provide connectivity between devices which may be located in different geographical areas and/or on different types of local networks (e.g., local/branch networks versus data center/cloud environments). For example, these routers may be interconnected by the public Internet, a multiprotocol label switching (MPLS) virtual private network (VPN), or the like. In some implementations, a router or a set of routers may be connected to a private network (e.g., dedicated leased lines, an optical network, etc.) or a VPN (e.g., MPLS VPN) thanks to a carrier network, via one or more links exhibiting different network and service level agreement characteristics.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art. Servers 104, for example, may be configured as a network controller/supervisory service located in a data center with databases 106, accordingly. For instance, servers 104 may include, in various implementations, a network management server (NMS), a dynamic host configuration protocol (DHCP) server, a constrained application protocol (CoAP) server, an outage management system (OMS), an application policy infrastructure controller (APIC), an application server, etc.

Those skilled in the art will also understand that any number of nodes, devices, links, etc. may be used in computing system 100, and that the view shown herein is for simplicity. As would also be appreciated, computing system 100 may include any number of local networks, data centers, cloud environments, devices/nodes, servers, etc. Also, those skilled in the art will further understand that while the network is shown in a certain orientation, the computing system 100 is merely an example illustration that is not meant to limit the disclosure.

For instance, smart object networks, such as sensor networks, in particular, are a specific type of network (e.g., computing system 100) having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Generally, size and cost constraints on smart object nodes (e.g., sensors) result in corresponding constraints on resources such as energy, memory, computational speed and bandwidth.

In some implementations, the techniques herein may be applied to still other network topologies and configurations. For example, the techniques herein may be applied to peering points with high-speed links, data centers, etc.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

According to various implementations, a software-defined WAN (SD-WAN) may be used in computing system 100 to connect local networks and data center/cloud environments. In general, an SD-WAN uses a software defined networking (SDN)-based approach to instantiate tunnels on top of the physical network and control routing decisions, accordingly. For example, one tunnel may connect a customer edge (CE) router at the edge of a local network to router a remote CE router at the edge of a data center/cloud environment over an MPLS or Internet-based service provider network in a network backbone. Similarly, a second tunnel may also connect these routers over a 4G/5G/LTE cellular service provider network. SD-WAN techniques allow the WAN functions to be virtualized, essentially forming a virtual connection between local networks and data center/cloud environments on top of the various underlying connections. Another feature of SD-WAN is centralized management by a supervisory service that can monitor and adjust the various connections, as needed.

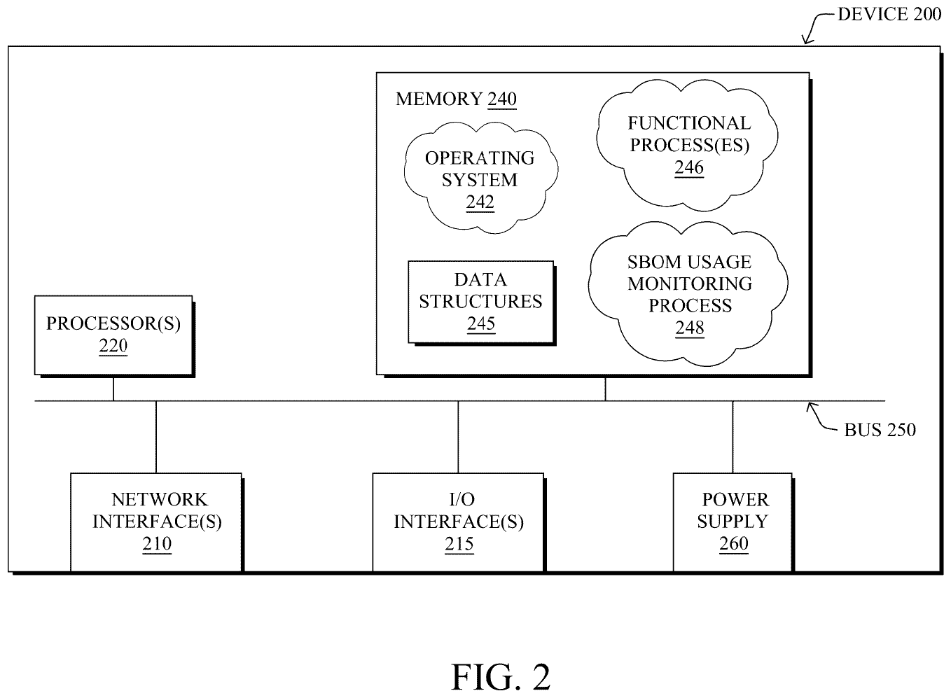

FIG. 2 is a schematic block diagram of an example node/device 200 (e.g., an apparatus) that may be used with one or more implementations described herein, e.g., as any of the nodes or devices shown in FIG. 1 above or described in further detail below.

The device 200 may comprise one or more of the network interfaces 210 (e.g., wired, wireless, etc.), input/output interfaces (I/O interfaces 215, inclusive of any associated peripheral devices such as displays, keyboards, cameras, microphones, speakers, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise one or more functional processes 246, and on certain devices, an “SBOM usage monitoring” process (process 248), as described herein, each of which may alternatively be located within individual network interfaces. Notably, one or more functional processes 246, when executed by processor(s) 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

Notably, the techniques herein may employ any number of machine learning techniques, such as to evaluate ingested data as described herein. In general, machine learning is concerned with the design and the development of techniques that receive empirical data as input (e.g., collected metric/event data from agents, sensors, etc.) and recognize complex patterns in the input data. For example, some machine learning techniques use an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function is a function of the number of misclassified points. The learning process then operates by adjusting the parameters a, b, c such that the number of misclassified points is minimal. After this optimization/learning phase, the techniques herein can use the model M to classify new data points. Often, M is a statistical model, and the cost function is inversely proportional to the likelihood of M, given the input data.

One class of machine learning techniques that is of particular use herein is clustering. Generally speaking, clustering is a family of techniques that seek to group data according to some typically predefined or otherwise determined notion of similarity.

Also, the performance of a machine learning model can be evaluated in a number of ways based on the number of true positives, false positives, true negatives, and/or false negatives of the model.

In various implementations, such techniques may employ one or more supervised, unsupervised, or semi-supervised machine learning models. Generally, supervised learning entails the use of a training set of data, as noted above, that is used to train the model to apply labels to the input data. On the other end of the spectrum are unsupervised techniques that do not require a training set of labels. Notably, while a supervised learning model may look for previously seen patterns that have been labeled as such, an unsupervised model may attempt to analyze the data without applying a label to it. Semi-supervised learning models take a middle ground approach that uses a greatly reduced set of labeled training data.

Example machine learning techniques that the techniques herein can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), multi-layer perceptron (MLP) artificial neural networks (ANNs) (e.g., for non-linear models), replicating reservoir networks (e.g., for non-linear models, typically for time series), random forest classification, or the like.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

### Observability Intelligence Platform

As noted above, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a software as a service (SaaS) over a network, such as the Internet. As an example, a distributed application can be implemented as a SaaS-based web service available via a web site that can be accessed via the Internet. As another example, a distributed application can be implemented using a cloud provider to deliver a cloud-based service.

Users typically access cloud-based/web-based services (e.g., distributed applications accessible via the Internet) through a web browser, a light-weight desktop, and/or a mobile application (e.g., mobile app) while the enterprise software and user's data are typically stored on servers at a remote location. For example, using cloud-based/web-based services can allow enterprises to get their applications up and running faster, with improved manageability and less maintenance, and can enable enterprise IT to more rapidly adjust resources to meet fluctuating and unpredictable business demand. Thus, using cloud-based/web-based services can allow a business to reduce Information Technology (IT) operational costs by outsourcing hardware and software maintenance and support to the cloud provider.

However, a significant drawback of cloud-based/web-based services (e.g., distributed applications and SaaS-based solutions available as web services via web sites and/or using other cloud-based implementations of distributed applications) is that troubleshooting performance problems can be very challenging and time consuming. For example, determining whether performance problems are the result of the cloud-based/web-based service provider, the customer's own internal IT network (e.g., the customer's enterprise IT network), a user's client device, and/or intermediate network providers between the user's client device/internal IT network and the cloud-based/web-based service provider of a distributed application and/or web site (e.g., in the Internet) can present significant technical challenges for detection of such networking related performance problems and determining the locations and/or root causes of such networking related performance problems. Additionally, determining whether performance problems are caused by the network or an application itself, or portions of an application, or particular services associated with an application, and so on, further complicate the troubleshooting efforts.

Certain aspects of one or more implementations herein may thus be based on (or otherwise relate to or utilize) an observability intelligence platform for network and/or application performance management. For instance, solutions are available that allow customers to monitor networks and applications, whether the customers control such networks and applications, or merely use them, where visibility into such resources may generally be based on a suite of “agents” or pieces of software that are installed in different locations in different networks (e.g., around the world).

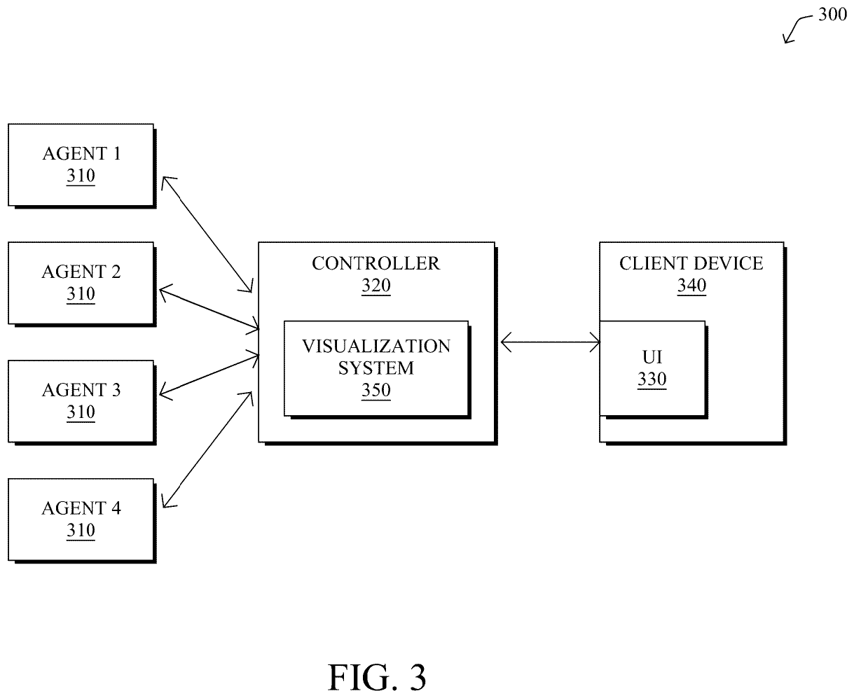

Specifically, as discussed with respect to illustrative FIG. 3 below, performance within any networking environment may be monitored, specifically by monitoring applications and entities (e.g., transactions, tiers, nodes, and machines) in the networking environment using agents installed at individual machines at the entities. As an example, applications may be configured to run on one or more machines (e.g., a customer will typically run one or more nodes on a machine, where an application consists of one or more tiers, and a tier consists of one or more nodes). The agents collect data associated with the applications of interest and associated nodes and machines where the applications are being operated. Examples of the collected data may include performance data (e.g., metrics, metadata, etc.) and topology data (e.g., indicating relationship information), among other configured information. The agent-collected data may then be provided to one or more servers or controllers to analyze the data.

Examples of different agents (in terms of location) may comprise cloud agents (e.g., deployed and maintained by the observability intelligence platform provider), enterprise agents (e.g., installed and operated in a customer's network), and endpoint agents, which may be a different version of the previous agents that is installed on actual users'(e.g., employees') devices (e.g., on their web browsers or otherwise). Other agents may specifically be based on categorical configurations of different agent operations, such as language agents (e.g., Java agents,. Net agents, PHP agents, and others), machine agents (e.g., infrastructure agents residing on the host and collecting information regarding the machine which implements the host such as processor usage, memory usage, and other hardware information), and network agents (e.g., to capture network information, such as data collected from a socket, etc.).

Each of the agents may then instrument (e.g., passively monitor activities) and/or run tests (e.g., actively create events to monitor) from their respective devices, allowing a customer to customize from a suite of tests against different networks and applications or any resource that they're interested in having visibility into, whether it's visibility into that end point resource or anything in between, e.g., how a device is specifically connected through a network to an end resource (e.g., full visibility at various layers), how a website is loading, how an application is performing, how a particular business transaction (or a particular type of business transaction) is being effected, and so on, whether for individual devices, a category of devices (e.g., type, location, capabilities, etc.), or any other suitable implementation of categorical classification.

FIG. 3 is a block diagram of an example observability intelligence platform 300 that can implement one or more aspects of the techniques herein. The observability intelligence platform is a system that monitors and collects metrics of performance data for a network and/or application environment being monitored. At the simplest structure, the observability intelligence platform includes one or more agents (agents 310) and one or more servers/controllers (e.g., controller 320). Agents may be installed on network browsers, devices, servers, etc., and may be executed to monitor the associated device and/or application, the operating system of a client, and any other application, API, or another component of the associated device and/or application, and to communicate with (e.g., report data and/or metrics to) the controller 320 as directed. Note that while FIG. 3 shows four agents (e.g., Agent 1 through Agent 4) communicatively linked to a single controller, the total number of agents and controllers can vary based on a number of factors including the number of networks and/or applications monitored, how distributed the network and/or application environment is, the level of monitoring desired, the type of monitoring desired, the level of user experience desired, and so on.

For example, instrumenting an application with agents may allow a controller to monitor performance of the application to determine such things as device metrics (e.g., type, configuration, resource utilization, etc.), network browser navigation timing metrics, browser cookies, application calls and associated pathways and delays, other aspects of code execution, etc. Moreover, if a customer uses agents to run tests, probe packets may be configured to be sent from agents to travel through the Internet, go through many different networks, and so on, such that the monitoring solution gathers all of the associated data (e.g., from returned packets, responses, and so on, or, particularly, a lack thereof). Illustratively, different “active” tests may comprise HTTP tests (e.g., using curl to connect to a server and load the main document served at the target), Page Load tests (e.g., using a browser to load a full page—i.e., the main document along with all other components that are included in the page), or Transaction tests (e.g., same as a Page Load, but also performing multiple tasks/steps within the page—e.g., load a shopping website, log in, search for an item, add it to the shopping cart, etc.).

The controller 320 is the central processing and administration server for the observability intelligence platform. The controller 320 may serve a browser-based user interface (UI) (interface 330) that is the primary interface for monitoring, analyzing, and troubleshooting the monitored environment. Specifically, the controller 320 can receive data from agents 310 (and/or other coordinator devices), associate portions of data (e.g., topology, business transaction end-to-end paths and/or metrics, etc.), communicate with agents to configure collection of the data (e.g., the instrumentation/tests to execute), and provide performance data and reporting through the interface 330. The interface 330 may be viewed as a web-based interface viewable by a client device 340. In some implementations, a client device 340 can directly communicate with controller 320 to view an interface for monitoring data. The controller 320 can include a visualization system 350 for displaying the reports and dashboards related to the disclosed technology. In some implementations, the visualization system 350 can be implemented in a separate machine (e.g., a server) different from the one hosting the controller 320.

Notably, in an illustrative Software as a Service (SaaS) implementation, an instance of controller 320 may be hosted remotely by a provider of the observability intelligence platform 300. In an illustrative on-premises (On-Prem) implementation, a controller instance may be installed locally and self-administered.

The controllers 320 receive data from different agents (e.g., Agents 1-4) deployed to monitor networks, applications, databases and database servers, servers, and end user clients for the monitored environment. Any of the agents 310 can be implemented as different types of agents with specific monitoring duties. For example, application agents may be installed on each server that hosts applications to be monitored. Instrumenting an agent adds an application agent into the runtime process of the application.

Database agents, for example, may be software (e.g., a Java program) installed on a machine that has network access to the monitored databases and the controller. Standalone machine agents, on the other hand, may be standalone programs (e.g., standalone Java programs) that collect hardware-related performance statistics from the servers (or other suitable devices) in the monitored environment. The standalone machine agents can be deployed on machines that host application servers, database servers, messaging servers, Web servers, etc. Furthermore, end user monitoring (EUM) may be performed using browser agents and mobile agents to provide performance information from the point of view of the client, such as a web browser or a mobile native application. Through EUM, web use, mobile use, or combinations thereof (e.g., by real users or synthetic agents) can be monitored based on the monitoring needs.

Note that monitoring through browser agents and mobile agents are generally unlike monitoring through application agents, database agents, and standalone machine agents that are on the server. In particular, browser agents may generally be embodied as small files using web-based technologies, such as JavaScript agents injected into each instrumented web page (e.g., as close to the top as possible) as the web page is served, and are configured to collect data. Once the web page has completed loading, the collected data may be bundled into a beacon and sent to an EUM process/cloud for processing and made ready for retrieval by the controller. Browser real user monitoring (Browser RUM) provides insights into the performance of a web application from the point of view of a real or synthetic end user. For example, Browser RUM can determine how specific Ajax or iframe calls are slowing down page load time and how server performance impact end user experience in aggregate or in individual cases. A mobile agent, on the other hand, may be a small piece of highly performant code that gets added to the source of the mobile application. Mobile RUM provides information on the native mobile application (e.g., iOS or Android applications) as the end users actually use the mobile application. Mobile RUM provides visibility into the functioning of the mobile application itself and the mobile application's interaction with the network used and any server-side applications with which the mobile application communicates.

Note further that in certain implementations, in the application intelligence model, a business transaction represents a particular service provided by the monitored environment. For example, in an e-commerce application, particular real-world services can include a user logging in, searching for items, or adding items to the cart. In a content portal, particular real-world services can include user requests for content such as sports, business, or entertainment news. In a stock trading application, particular real-world services can include operations such as receiving a stock quote, buying, or selling stocks.

A business transaction, in particular, is a representation of the particular service provided by the monitored environment that provides a view on performance data in the context of the various tiers that participate in processing a particular request. That is, a business transaction, which may be identified by a unique business transaction identification (ID), represents the end-to-end processing path used to fulfill a service request in the monitored environment (e.g., adding items to a shopping cart, storing information in a database, purchasing an item online, etc.). Thus, a business transaction is a type of user-initiated action in the monitored environment defined by an entry point and a processing path across application servers, databases, and potentially many other infrastructure components. Each instance of a business transaction is an execution of that transaction in response to a particular user request (e.g., a socket call, illustratively associated with the TCP layer). A business transaction can be created by detecting incoming requests at an entry point and tracking the activity associated with request at the originating tier and across distributed components in the application environment (e.g., associating the business transaction with a 4-tuple of a source IP address, source port, destination IP address, and destination port). A flow map can be generated for a business transaction that shows the touch points for the business transaction in the application environment. In one implementation, a specific tag may be added to packets by application specific agents for identifying business transactions (e.g., a custom header field attached to a hypertext transfer protocol (HTTP) payload by an application agent, or by a network agent when an application makes a remote socket call), such that packets can be examined by network agents to identify the business transaction identifier (ID) (e.g., a Globally Unique Identifier (GUID) or Universally Unique Identifier (UUID)). Performance monitoring can be oriented by business transaction to focus on the performance of the services in the application environment from the perspective of end users. Performance monitoring based on business transactions can provide information on whether a service is available (e.g., users can log in, check out, or view their data), response times for users, and the cause of problems when the problems occur.

In accordance with certain implementations, the observability intelligence platform may use both self-learned baselines and configurable thresholds to help identify network and/or application issues. A complex distributed application, for example, has a large number of performance metrics and each metric is important in one or more contexts. In such environments, it is difficult to determine the values or ranges that are normal for a particular metric; set meaningful thresholds on which to base and receive relevant alerts; and determine what is a “normal” metric when the application or infrastructure undergoes change. For these reasons, the disclosed observability intelligence platform can perform anomaly detection based on dynamic baselines or thresholds, such as through various machine learning techniques, as may be appreciated by those skilled in the art. For example, the illustrative observability intelligence platform herein may automatically calculate dynamic baselines for the monitored metrics, defining what is “normal” for each metric based on actual usage. The observability intelligence platform may then use these baselines to identify subsequent metrics whose values fall out of this normal range.

In general, data/metrics collected relate to the topology and/or overall performance of the network and/or application (or business transaction) or associated infrastructure, such as, e.g., load, average response time, error rate, percentage CPU busy, percentage of memory used, etc. The controller UI can thus be used to view all of the data/metrics that the agents report to the controller, as topologies, heatmaps, graphs, lists, and so on. Illustratively, data/metrics can be accessed programmatically using a Representational State Transfer (REST) API (e.g., that returns either the JavaScript Object Notation (JSON) or the eXtensible Markup Language (XML) format). Also, the REST API can be used to query and manipulate the overall observability environment.

Those skilled in the art will appreciate that other configurations of observability intelligence may be used in accordance with certain aspects of the techniques herein, and that other types of agents, instrumentations, tests, controllers, and so on may be used to collect data and/or metrics of the network(s) and/or application(s) herein. Also, while the description illustrates certain configurations, communication links, network devices, and so on, it is expressly contemplated that various processes may be embodied across multiple devices, on different devices, utilizing additional devices, and so on, and the views shown herein are merely simplified examples that are not meant to be limiting to the scope of the present disclosure.

### Sbom Component Usage

As noted above, Software Bill of Materials (SBOMs) allow for the quick identification of the software components involved in everything from transactions to application programming interfaces (APIs) in applications. In general, an SBOM is typically constructed today by the build system and then bundled with the software produced by that system. That is, SBOMs provide a formal record containing the details and supply chain relationships of various components used in building software. In other words, SBOMs function as a list of components that make up an application, similar to ingredient labels on food, where an SBOM may list all of the libraries that the application uses, its API calls, and the like.

SBOMs are particularly useful for the purposes of cybersecurity. For instance, the U.S. government has recently mandated that all software sales to the federal government include SBOMs. However, SBOMs merely indicate what the components (ingredients) *are* in the software, but now *how much* those components contribute to the software. In some cases, these components maybe not even be used by an application, but instead was listed in an SBOM because it was a part of the build and not part of the deployment. This can defeat the entire purpose of an SBOM if it's not accurate or if it's simply misleading.

Most SBOMs are generated in the build phase-and generated from “static” libraries, etc. in folders related to a build-not an actual runtime. The runtime is the most accurate depiction of exactly what is used and how much of it is used. To date, there are no SBOMs that list runtime metrics that can delineate exactly how much the components are actually involved in the overall operation of the runtime, which in turn helps identify risk. For example, there may be zero risk from a component that is not used, while there may be a significant risk from a component used in seventy percent or more of the operation of the product.

The techniques herein, therefore, provide techniques for determining SBOM component usage. That is, the techniques herein introduce an agent that measures the usage of the various SBOM components of an application, e.g., thereby giving certain components more relevance over others as to business risk by correlating overall usage (or non usage), functionality, and context with those components based on runtime metrics.

Specifically, according to one or more embodiments of the disclosure as described in detail below, an illustrative method herein may comprise: obtaining a software bill of materials for an application, the software bill of materials listing a plurality of components associated with the application; monitoring runtime execution of the application; measuring usage of each individual component of the plurality of components associated with the application during the runtime execution of the application; and generating a usage report for the software bill of materials based on the usage each individual component of the plurality of components associated with the application during the runtime execution of the application.

As mentioned above, SBOMs were quickly adopted by private enterprise companies and are becoming a standard to make available for the purposes of assessing risk in the use of the product. That is, SBOMs have emerged as a key building block in software security and software supply chain risk management. In general, an SBOM is a nested inventory, which can be thought of as a list of ingredients that make up software components of a software system.

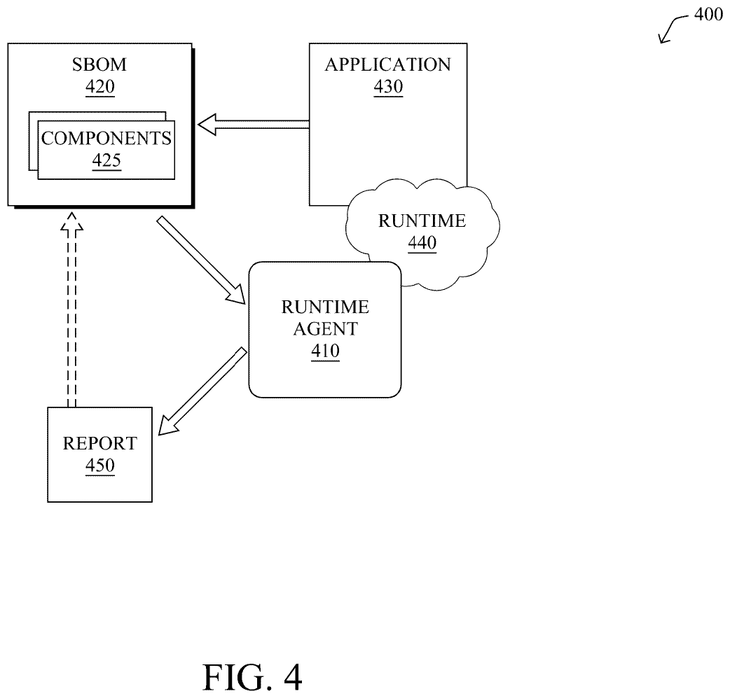

Operationally, and as shown in environment 400 of FIG. 4, the techniques herein center around a runtime agent 410 that reads an SBOM 420 of an application 430, and then based on that monitors (e.g., instruments and/or samples) the runtime 440 to actually determine a level of contribution of each component 425 of the SBOM to the runtime 440 (e.g., a percentage of how much CPU is dedicated to each of the SBOM components). That is, in order to determine a dependency of the application on each component within an SBOM, the techniques herein monitor (via runtime agent 410) the application while executing in order to extract usage information. The techniques herein may then generate a report 450 of the levels of contribution of each component 425 (e.g., a separate report and/or an update to the SBOM 420). Optionally, the report 450 may also include other informative factors such as, for example, average, standard deviation, baselining, and so on.

By providing a “runtime-enhanced SBOM”, the techniques herein create a more accurate picture for analysis and/or risk assessment, as well as just a better understanding of the dependency of an application on certain components, thus strengthening the overall SBOM relevance. In particular, as noted, some components may not even be used by an application during runtime, and others may be heavily involved. However, without monitoring the operation of the application at runtime, it would be nearly impossible to determine how often and where/when each component was, in fact, contributing to the application.

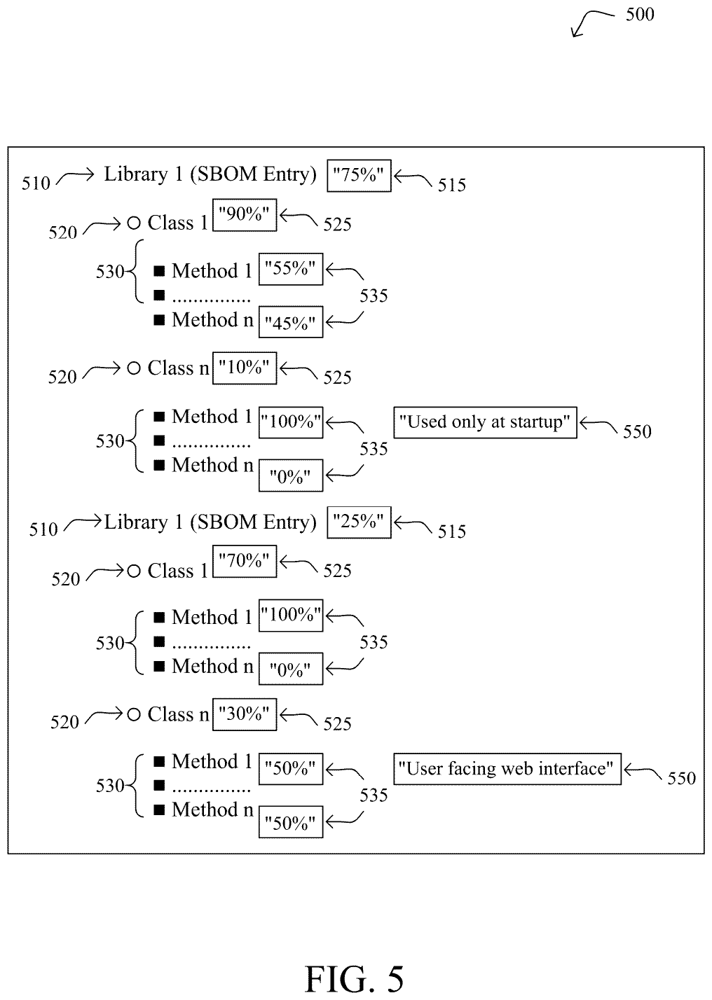

FIG. 5 illustrates an example runtime-enhanced SBOM, SBOM 500 (e.g., based on report 450 or as the report 450 above), built in accordance with one or more aspects of the present disclosure as described herein. In particular, SBOM 500 may illustratively contain a listing of:
Materials 510 (e.g., libraries) and dependency 515 on that material (e.g., a percentage of time spent by the application within this material, or alternatively an amount of time spent during testing);
Classes 520 from each material, and for each class, an amount of time 525 (e.g., percentage or actual) that the runtime was executing that class (e.g., as a proportion of the time within that material, where classes in each material/library total 100%, or as a proportion of the whole runtime, where classes in a material/library total the amount/percentage of time of the material/library);
Methods 530 within the classes 520, and for each method, an amount of time 535 (e.g., percentage or actual) each method in the class was executing (e.g., as a proportion of the time within that class, where methods in each class total 100%, or as a proportion of the whole runtime, where methods in a class total the amount/percentage of time of the class).

The result is a true representation of how the components of the SBOM 500 impacted the runtime. For instance, as shown in the simplified illustration of SBOM 500, assume that “Library 1” takes up 75% of the total runtime of an application, while “Library n” is 25%. (Note that there may be many libraries, classes, and methods, and the view shown in FIG. 5 is merely for discussion.)

Within Library 1, “Class 1” was most impactful at 90% of Library 1's utilization, with time spent closely between “Method 1” and “Method n” at 55% and 45% respectively. “Class n” was less impactful to Library 1, with a utilization at 10%, and “Method 1” of Class n being the sole contributor at 100% (“Method n” of Class n never being used during runtime, 0%).

Similarly, within Library n, “Class 1” was reasonably impactful at 70%, but “Method 1” was shown to be 100% of the reason, where “Method n” was unused (0%). “Class n” at 30% was less used withing Library n, but “Method 1” and “Method n” were divided evenly at 50% each.

Here, runtime dependencies on each component of the SBOM can be readily apparent. For instance, through simple math, Library 1 was 75% of the runtime, Class 1 of Library 1 was 67.5% of total runtime (90% of that 75%), and Method 1 of Class 1 of Library 1 was 37.125% of total runtime (55% of that 67.5%). Alternatively, as noted above, the SBOM 500 format could be altered to show those overall percentages, correspondingly, for example:
Library 1: 75%
   Class 1: 67.5%
      Method 1: 37.125%
      Method 2: 30.375%
And so on.

Illustratively, therefore, it would be clear to an analysis of SBOM 500 that Class 1 of Library 1 is the majority of operation of the application, with each of Methods 1 and 2 taking up around a third of the operation of the application. It would also be clear that Method n of Class 1 of Library n was unused, as was Method n of Class n of Library 1.

Thus, when assessing a level of risk associated with the individual components of the SBOM, it should be apparent that Methods 1 and 2 of Class 1 of Library 1 are far more impactful than the unused methods noted. As such, SBOM 500 is not just a list, but it is a vehicle for insight, carrying valuable information on each component's influence, and what a corresponding impact may be if vulnerabilities were exposed, or if changes were made, and so on.

According to various implementations herein, additional information and/or context about the components of the SBOM (info 550) might contain:
A timing context, such as whether the component is used only at startup/bootstrap, only once in general, or else is used through execution of the application;
Whether the code is involved in a user/customer facing interface (e.g., a web interface), and if so, what is the Business Importance of the interface within the SBOM
CI/CD (continuous integration/continuous delivery) sample burn as a build step might be part of a plugin;
Whether certain components/artifacts are used in every transaction or only certain transactions, and if the latter, what triggers that use;
And so forth.

As mentioned above, the extracted information may be appended to an original SBOM, or may be generated as a new SBOM, or may be formatted otherwise as a separate report of findings. Also, the original or newly generated SBOM could be arranged (re-arranged) as an ordered list of components as opposed to following the original listing order of materials/libraries, classes, methods. Any suitably appropriate format to portray the information obtained by monitoring the runtime may be used in accordance with the techniques herein, and those shown or described are not meant to limit the scope of the present disclosure.

According to one or more embodiments of the present disclosure, the techniques herein may monitor the runtime of the application in a number of ways. For instance, one such mechanism that may be used herein is instrumentation. That is, instrumentation is used in applications to measure things such as latency, to detect exploits, and so on. Essentially, instrumentation can monitor anything that enters or exits an application by injecting into a class. This instrumentation can also detect whether or not a class is being used and how many times different components are being called in the class. Additionally, instrumentation code can be written to understand the “context” of a call, which is key to the application performance (e.g., is this a one-time bootstrap or a repetitive call?).

Alternatively or in addition, stack sampling may also be used to monitor the runtime. Stack sampling, in particular, would be similar to instrumentation, but would also be less invasive. In this case, the techniques herein would review the call stacks at regular intervals and record what the currently executing method is. The techniques herein may then map that to the class, and then from the class to the component in the SBOM, and may then calculate/record the usage, accordingly.

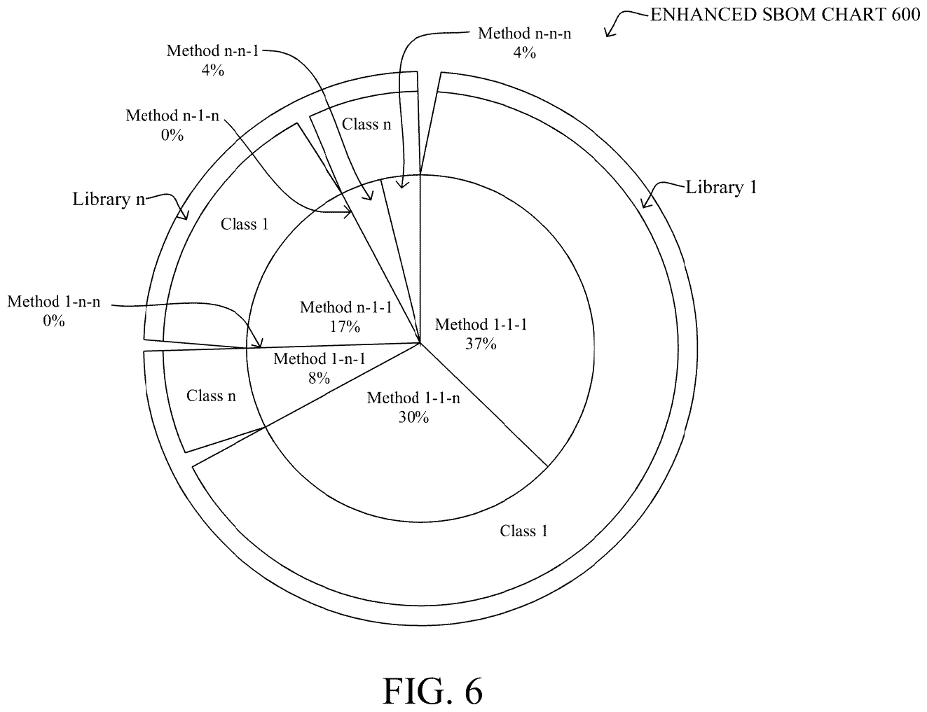

FIG. 6 illustrates an example graphical representation 600 of SBOM component usage, which may be generated as part of a graphical user interface (GUI). Note that while the example graphical representation 600 is shown as a pie chart, other representations may be generated herein, and the chart shown is not meant to limit the scope of the embodiments herein. As shown, the chart (or other graph) demonstrates exactly how much the actual components (“ingredients”) are involved in the overall operation of the runtime, which in turn helps to easily identify dependency/risk.

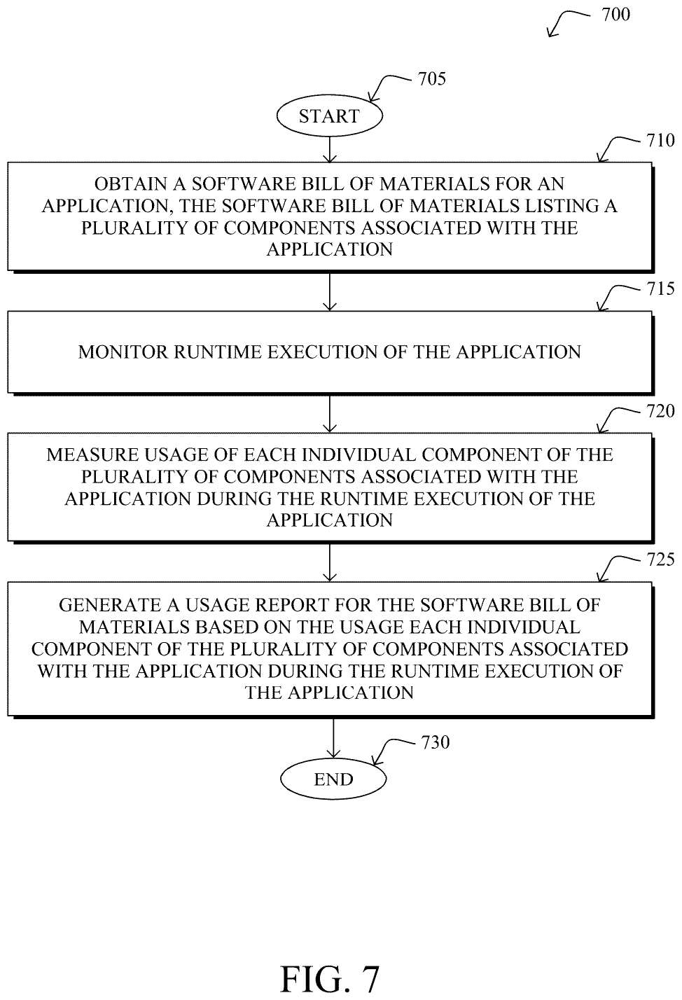

In closing, FIG. 7 illustrates an example simplified procedure for software bill of materials (SBOM) component usage in accordance with one or more embodiments described herein, particularly from the perspective of an agent. For example, a non-generic, specifically configured device (e.g., device 200, an apparatus) may perform procedure 700 by executing stored instructions (e.g., process 248). The procedure 700 may start at step 705, and continues to step 710, where, as described in greater detail above, the process (e.g., an agent) obtains a software bill of materials for an application, the software bill of materials listing a plurality of components associated with the application. In one embodiment, the process reads the software bill of materials to determine the plurality of components to monitor. In another embodiment, as opposed to reading a static SBOM (or to confirm it), the process may be configured to dynamically generate the SBOM based on monitoring the application.

In step 715, in particular, the process may monitor runtime execution of the application, such as by either instrumenting the application to monitor the runtime execution of the application, or else by stack sampling the application to review call stacks to determine executed methods and then mapping the executed methods to the plurality of components, each as detailed above.

In step 720, the process measures usage of each individual component of the plurality of components associated with the application during the runtime execution of the application, and then in step 725 generates a usage report for the software bill of materials based on the usage each individual component of the plurality of components associated with the application during the runtime execution of the application. As noted above, the report may be separate (e.g., an individual report and/or graphical representation), or else may be “generated” by appending the usage report into the software bill of materials itself.

Notably, as described above, the usage report may be formatted in a number of different configurations and with different components of information. For instance, in one embodiment, the usage report indicates a dependency of the application on the plurality of components. In another embodiment, the usage report indicates, for each class within the software bill of materials, an amount of time the runtime execution of the application was executing that class. In still another embodiment, the usage report indicates, for each method within the software bill of materials, an amount of time the runtime execution of the application was executing that method. Combinations of the above may also be reported, and the example embodiments are not meant to be mutually exclusive herein.

Furthermore, as detailed above, the usage report may also indicate an additional “assessment notation” with one or more of the plurality of components. For instance, the additional assessment notation may indicate a relative timing and/or occasionality of execution of a corresponding component (e.g., startup/bootstrap only, one time use, periodic use, constant use, etc.). Alternatively or in addition, the additional assessment notation may indicate whether a corresponding component is internal to the application or an external call to outside of the application. Other additional assessment notations may be determined according to the techniques herein, such as various flags, security notices, anomalies (e.g., as detected by various machine learning/artificial intelligence engines), and any other information deemed useful for inclusion within the usage report that may increase the insight provided by the report based on monitoring the runtime activity of execution of the application, accordingly.

Procedure 700 may end at step 730.

It should be noted that while certain steps within the procedures above may be optional as described above, the steps shown in the procedures above are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures may have been described separately, certain steps from each procedure may be incorporated into each other procedure, and the procedures are not meant to be mutually exclusive.

The techniques described herein, therefore, provide for software bill of materials (SBOM) component usage, finding dependencies between components and profiling how they are actually used during a runtime load test. That is, while many tools exist to generate an SBOM, there is no information provided in terms of “quantity” or usage levels. Without such information, it can be difficult to quantify the degree of risk (security-wise or liability-wise) any given component has on the system, where some components may be inactive, some rarely used, and some a very integral part of the operation, each correspondingly being associated with their own level of impact on the system.

Today's vulnerability scanners do not explain which components are actually being used and how much, and none perform any operations at the application level (e.g., tracking the classes, methods, code, etc.). Moreover, “runtime scanners” available today generally are just looking at the operating system library loading and they only know that something was loaded or not—they have no idea how much usage they have or other specifics such as what functionality they are providing.

What the techniques herein are doing is fundamentally different. Instead of being an ad hoc developer tool that “probes” a running system in production, the techniques herein “profile” the system during load testing, allowing for the identification of dependencies, developing an understanding of how they are used, and providing application stakeholders with a detailed view of the role these dependencies play in the application—both in terms of usage and life cycle. The techniques herein thus help stakeholders assess the associated business risk.

Said differently, the techniques herein provide the ability to measure and report the usage of components within an SBOM, where current SBOM generators simply list all components without indicating the relative significance or usage of these components. In some cases, a software component might not even be present in the runtime environment, such as when a vulnerable component is included in a dependency that the main application logic doesn't reference (e.g., a residual artifact). That is, existing SBOMs fail to capture the actual business risk tied to component usage. The techniques herein introduce a new result by measuring and reporting this usage, providing a clearer picture of the business risk associated with each component.

Illustratively, the techniques described herein may be performed by hardware, software, and/or firmware, (e.g., an “apparatus”) such as in accordance with the SBOM usage monitoring process, process 248, e.g., a “method”), which may include computer-executable instructions executed by the processor(s) 220 to perform functions relating to the techniques described herein, e.g., in conjunction with corresponding processes of other devices in the computer network as described herein (e.g., on agents, controllers, computing devices, servers, etc.). In addition, the components herein may be implemented on a singular device or in a distributed manner, in which case the combination of executing devices can be viewed as their own singular “device” for purposes of executing the process (e.g., process 248).

In some implementations, an illustrative apparatus herein may comprise: one or more network interfaces to communicate with a network; a processor coupled to the one or more network interfaces and configured to execute one or more processes; and a memory configured to store a process that is executable by the processor, the process comprising: obtaining a software bill of materials for an application, the software bill of materials listing a plurality of components associated with the application; monitoring runtime execution of the application; measuring usage of each individual component of the plurality of components associated with the application during the runtime execution of the application; and generating a usage report for the software bill of materials based on the usage each individual component of the plurality of components associated with the application during the runtime execution of the application.

In still other implementations, a tangible, non-transitory, computer-readable medium storing program instructions that cause a device to execute a process comprising: obtaining a software bill of materials for an application, the software bill of materials listing a plurality of components associated with the application; monitoring runtime execution of the application; measuring usage of each individual component of the plurality of components associated with the application during the runtime execution of the application; and generating a usage report for the software bill of materials based on the usage each individual component of the plurality of components associated with the application during the runtime execution of the application.

While there have been shown and described illustrative implementations above, it is to be understood that various other adaptations and modifications may be made within the scope of the implementations herein. For example, while certain implementations are described herein with respect to certain types of networks in particular, the techniques are not limited as such and may be used with any computer network, generally, in other implementations. Moreover, while specific technologies, protocols, architectures, schemes, workloads, languages, etc., and associated devices have been shown, other suitable alternatives may be implemented in accordance with the techniques described above. In addition, while certain devices are shown, and with certain functionality being performed on certain devices, other suitable devices and process locations may be used, accordingly.

Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

For instance, while certain aspects of the present disclosure are described in terms of being performed “by a server” or “by a controller” or “by a collection engine”, those skilled in the art will appreciate that agents of the observability intelligence platform (e.g., application agents, network agents, language agents, etc.) may be considered to be extensions of the server (or controller/engine) operation, and as such, any process step performed “by a server” need not be limited to local processing on a specific server device, unless otherwise specifically noted as such. Furthermore, while certain aspects are described as being performed “by an agent” or by particular types of agents (e.g., application agents, network agents, endpoint agents, enterprise agents, cloud agents, etc.), the techniques may be generally applied to any suitable software/hardware configuration (libraries, modules, etc.) as part of an apparatus, application, or otherwise.

As used herein, the terms “application” and “applications” generally refer to a computer program or computer programs that are designed to carry out a specific task or tasks other than task(s) relating to the operation of the computer itself. In particular, an “application” can refer to a collection of executable computer code that is provided to, or is integrated into, a software system. As a result, the “application” or “applications” discussed herein can refer to any collection computer code that is executed by, or provided by, the software system.

By way of example, the applications mentioned herein can be host applications that run on various computing systems, such as a physical computer (e.g., a desktop, a laptop, a smartphone, a tablet, a phablet, etc.), a virtual computer (e.g., a thin client, a virtual machine, a Linux container, etc.), a data center (e.g., rack server, supercomputer, etc.), and/or a software defined data center (e.g., bare metal server), etc. Accordingly, the applications described herein can be locally provided host applications, virtually provided host applications, and so on and so forth.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true intent and scope of the implementations herein.

What is claimed is:

1. A method, comprising:
obtaining, by a process, a software bill of materials for an application, the software bill of materials listing a plurality of components associated with the application;
monitoring, by the process, runtime execution of the application;
measuring, by the process, usage of each individual component of the plurality of components associated with the application during the runtime execution of the application; and
generating, by the process, a usage report for the software bill of materials based on the usage each individual component of the plurality of components associated with the application during the runtime execution of the application.

2. The method of claim 1, further comprising:
instrumenting the application to monitor the runtime execution of the application.

3. The method of claim 1, wherein monitoring comprises:
stack sampling the application to review call stacks to determine executed methods; and
mapping the executed methods to the plurality of components.

4. The method of claim 1, further comprising:
reading the software bill of materials to determine the plurality of components to monitor.

5. The method of claim 1, wherein the usage report indicates a dependency of the application on the plurality of components.

6. The method of claim 1, wherein the usage report indicates, for each class within the software bill of materials, an amount of time the runtime execution of the application was executing that class.

7. The method of claim 1, wherein the usage report indicates, for each method within the software bill of materials, an amount of time the runtime execution of the application was executing that method.

8. The method of claim 1, wherein generating the usage report comprises:
appending the usage report into the software bill of materials.

9. The method of claim 1, wherein the usage report indicates an additional assessment notation with one or more of the plurality of components.

10. The method of claim 9, wherein the additional assessment notation indicates a relative timing and/or occasionality of execution of a corresponding component.

11. The method of claim 9, wherein the additional assessment notation indicates whether a corresponding component is internal to the application or an external call to outside of the application.

12. A tangible, non-transitory, computer-readable medium storing program instructions that cause a device to execute a process comprising:
obtaining a software bill of materials for an application, the software bill of materials listing a plurality of components associated with the application;
monitoring runtime execution of the application;
measuring usage of each individual component of the plurality of components associated with the application during the runtime execution of the application; and
generating a usage report for the software bill of materials based on the usage each individual component of the plurality of components associated with the application during the runtime execution of the application.

13. The tangible, non-transitory, computer-readable medium of claim 12, further comprising:
instrumenting the application to monitor the runtime execution of the application.

14. The tangible, non-transitory, computer-readable medium of claim 12, wherein monitoring comprises:
stack sampling the application to review call stacks to determine executed methods; and
mapping the executed methods to the plurality of components.

15. The tangible, non-transitory, computer-readable medium of claim 12, wherein the usage report indicates a dependency of the application on the plurality of components.

16. The tangible, non-transitory, computer-readable medium of claim 12, wherein the usage report indicates, for each class within the software bill of materials, an amount of time the runtime execution of the application was executing that class.

17. The tangible, non-transitory, computer-readable medium of claim 12, wherein the usage report indicates, for each method within the software bill of materials, an amount of time the runtime execution of the application was executing that method.

18. The tangible, non-transitory, computer-readable medium of claim 12, wherein generating the usage report comprises:
appending the usage report into the software bill of materials.

19. The tangible, non-transitory, computer-readable medium of claim 12, wherein the usage report indicates an additional assessment notation with one or more of the plurality of components.

20. An apparatus, comprising:
one or more network interfaces to communicate with a network;
a processor coupled to the one or more network interfaces and configured to execute one or more processes; and
a memory configured to store a process that is executable by the processor, the process comprising:
obtaining a software bill of materials for an application, the software bill of materials listing a plurality of components associated with the application;
monitoring runtime execution of the application;
measuring usage of each individual component of the plurality of components associated with the application during the runtime execution of the application; and
generating a usage report for the software bill of materials based on the usage each individual component of the plurality of components associated with the application during the runtime execution of the application.
